(19) United States
(12) Patent Application Publication
(10) Pub. No.: US 2004/0076093 A1
(43) Pub. Date: Apr. 22, 2004

(54) Method for storing/reproducing information and information recorder and digital camera

(76) Inventors: Kouichi Kawakami, Nara (JP); Hiromi Hamano, Osaka (JP); Masahiko Tomikawa, Tokyo (JP)

Correspondence Address: ARMSTRONG, KRATZ, QUINTOS, HANSON & BROOKS, LLP, 1725 K STREET, NW, SUITE 1000, WASHINGTON, DC, 20006, US

(21) Appl. No.: 10/466,323

(22) PCT Filed: Jan. 28, 2002
(86) PCT No.: PCT/JP02/00628

(30) Foreign Application Priority Data
Jan. 31, 2001 (JP) 2001-23057

(51) Int. Cl. G11B 7/00

(52) U.S. Cl. 369/47.14; 369/53.17

(57) ABSTRACT

An objective of the present invention is reading out information correctly from a defective area when a recording medium having a plurality of defective management areas is used. If information is read out correctly from two or more defective recording areas of the recording medium, that information is used.

### TECHNICAL FIELD

The present invention relates to information memory devices, and more particularly to an information memory device for use in digital cameras for storing information as to images such as still images.

### BACKGROUND ART

Semiconductor memories, hard disks, magneto-optical disks are used as memory devices for digital cameras for recording mainly still images. Semiconductor memories have the drawback of being relatively small in recording capacity, and memory devices which are small but have a great capacity are required with the transition of the digital camera recording function from still pictures to moving pictures. Accordingly, research and development efforts are made in an attempt to use hard disks, magneto-optical disks, DVD disks and like recording media as recording devices for digital cameras. Such recording media require processing different from that of conventional semiconductor memories.

Extreme difficulties are encountered, for example, with magneto-optical disks in completely eliminating the defects from the disk surface in the process for fabricating the disk. The disk surface usually includes some defective area, hence the need to manage the disk areas so as not to use the defective area for recording or playback. For example, the disk is certified in its entirety before use to detect a defective area so as not to use this area. For this purpose, it is desired to provide on the disk a area for storing therein information as to the defective area such as the position of the defective area.

If the information as to the defective area is stored in a specified area on the disk, i.e., in a defect management area, the information is read from the defect management area and utilized when the disk is used. This obviates the need to detect the defective area by a specific procedure, hence efficiency.

### SUMMARY OF THE INVENTION

As described above, recording media have a area not usable for recording or playback, and for information recording devices for use with recording media wherein information as to the unusable area is recorded in a defect management area, the information in the defect management area is of extreme importance in using disks. If the information can be read correctly from the defect management area, there is no need to certify disks every time the disk is to be used to ensure a high efficiency. Accordingly, it is important to read the information from the defect management area without errors. The present invention provides an information recording device which is adapted to read information from such a defect management area free of errors.

The present invention provides an information recording device for use with magneto-optical disks having a plurality of defect management areas having stored therein the same content, the device being characterized in that when information can be read correctly from at least two of the defect management areas through an initialization procedure, the read information is utilized.

The present invention further provides an information recording-reproducing method characterized in that when information can be correctly read from a plurality of defect management areas in reading defect management information from a recording medium having detect management areas, reading data from or writing data to the recording medium is permitted, the recording medium being handled as a recording medium for exclusive use in reproduction when information can be read from only one of the areas.

Further according to the invention, the information recording-reproducing method is characterized in that when there is an area failing to provide information through reading in reading the defect management information, the data successfully read from an area is written to the area failing to provide the information through reading.

Further in updating the defect management information during a recording-reproduction operation for the recording medium in the information recording-reproducing method of the invention, the defect management information is updated after the detect management information has been read from all the defect management areas.

The information recording-reproducing method of the invention is further characterized in that when the defect management information can be updated at only one location, the recording medium is handled as a recording medium for exclusive use in reproduction.

### BRIEF DESCRIPTION OF THE DRAWINGS

FIG. 1 is a block diagram schematically showing an embodiment of the invention.

FIG. 2 is a plan view showing a magneto-optical disk.

FIG. 3 is a flow chart showing a DMA reading operation of the embodiment.

FIG. 4 is a flow chart showing a DMA writing operation of the embodiment.

FIG. 5 is a diagram for illustrating a measure against faulty DMA.

### BEST MODE OF CARRYING OUT THE INVENTION

A description will be given of a digital camera embodying the invention. The appearance of the camera and outline of operation thereof will not be illustrated or described in detail. As is already well known, the digital camera comprises a CCD for forming thereon images by optical system which are subjected to digital processing and to predetermined compression processing such as JPEG for conversion to a format suited to recording, and the converted data is recorded on a memory medium such as a semiconductor memory card.

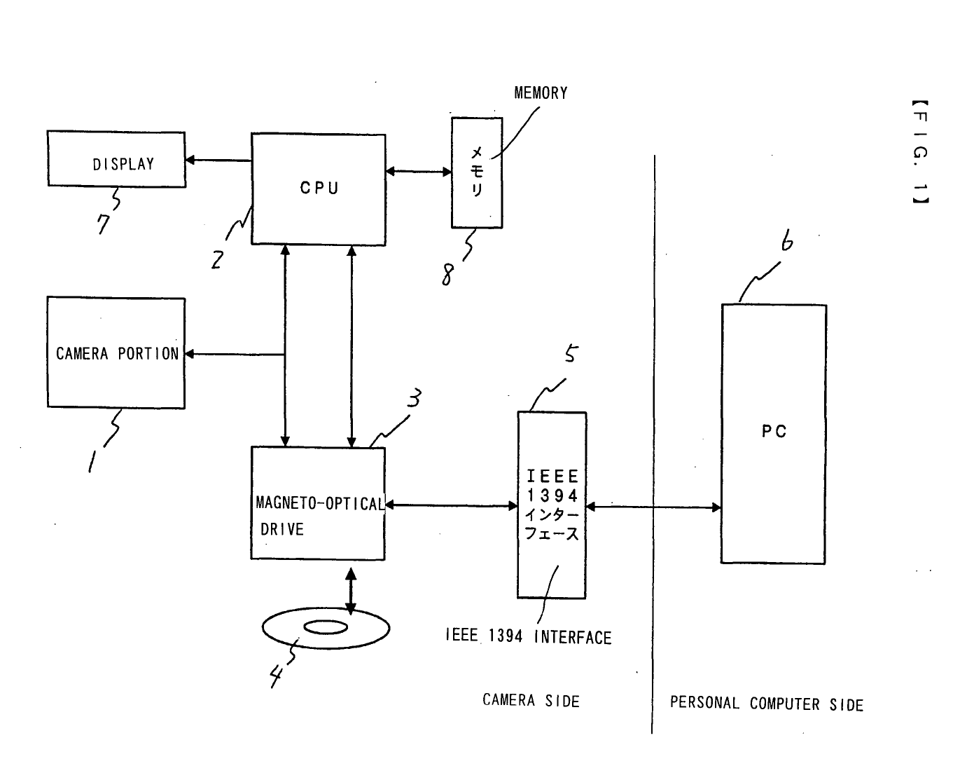

FIG. 1 is a block diagram showing the relationship between the main portion of the digital camera and a personal computer. A camera portion 1 is a block for processing an image signal from the CCD in a predetermined manner, and a CPU 2 is a microcomputer for controlling the operation of the camera portion 1 and a magneto-optical drive. The magneto-optical drive 3 is a block by which predetermined information is recorded on or reproduced from a magneto-optical disk 4. Indicated at 5 is an IEEE 1394 interface for allowing the transfer of data and commands between the magneto-optical drive 3 and the personal computer 6. Indicated at 7 is a display for presenting various items of information for manipulating the digital camera. The display 7 has the function of displaying a camera control menu, reproducing and displaying recorded still pictures or moving pictures, and a photographic viewfinder function.

Indicated at 8 is a memory use by the CPU 2, for example, for temporarily storing the information read from the magneto-optical disk 4 and concerning detective areas of the disk 4 to be described below.

The image pickup operation to be performed by the digital camera will be described briefly. The image information accumulated in the CCD by a shutter manipulation is subjected to signal processing by the camera portion 1, and the signals obtained are recorded in the magneto-optical disk 4 by the magneto-optical drive 3 under the control of the CPU 2. The image recorded on the disk 4 is read under the control of the CPU 2 and presented on the display 7 or transmitted to the personal computer 6 via the interface 5.

The recording-reproduction operation for the disk 4 is well known and will not be described in detail. An optical or thermomagnetic effect is utilized for recording and reproduction.

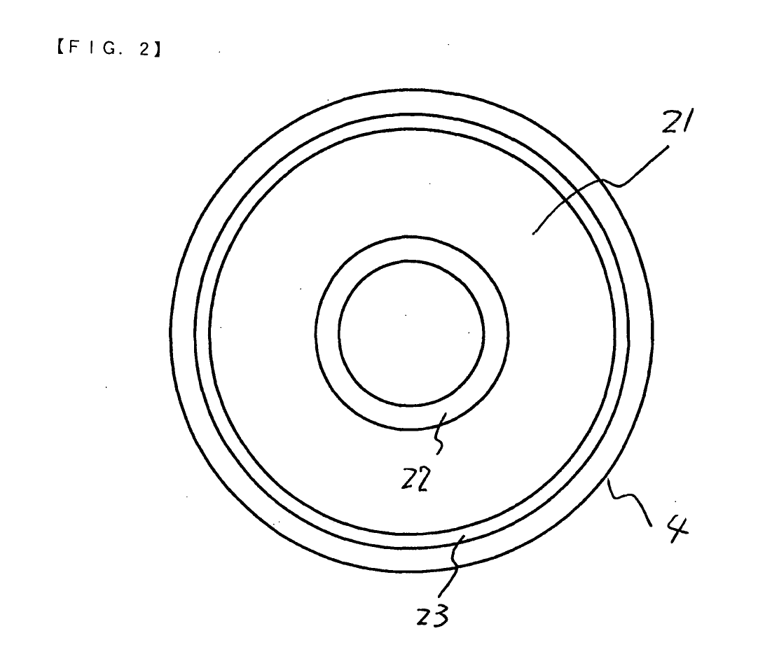

FIG. 2 is a diagram schematically showing the construction of the magneto-optical disk for use as a recording medium. The disk 4 has a defect management area (DMA) 22 radially inwardly of a user area 21 and another DMA 23 radially outwardly of the user area 21. The inner and outer DMA 22 and DMA 23 each have two defect management areas; these areas of the former area will be referred to as I1 and I2 (I standing for “inner”), and those of the latter area as O1 and O2 (O standing for “outer”). These DMAs all have recorded therein the same information as to defect management and include four blocks 52, 52 (to be described later).

For the effective use of the magneto-optical disk 4, the disk is theoretically divided into unit areas which are called sectors. A desired sector can be specified according to a predetermined addressing method for recording or playback. Since the individual sectors have the possibility of becoming faulty in the course of the disk manufacturing process, the sectors are not always usable for recording or playback.

The faulty sector need to be specified so as not to use the sector subsequently for recording or playback. For this purpose, the defect management areas (DMAs) of the disk are used. The physical address of the DMA on the disk can be specified by making distinction between band, track, frame, and land and groove, and each DMA has an area corresponding to 64 frames. Furthermore, each DMA includes four ECC blocks 52, 52 as will be described later.

As to a sector found to be faulty, the address thereof (and also the address of a substitute area, as the case may be) is recorded in the DMAs. Accordingly, when the disk is to be used next, the DMAs are checked to thereby obviate the likelihood of using the defective area for recording data therein or reproducing data therefrom.

Unless the information as to a defect is thus recorded in DMAs, the faulty sector is to be read for playback. However, such a case is interpreted as a playback error, giving rise to an objectionable result that the subsequent sectors can not be played back.

In view of the efficient use of disks, there are two methods of management of defects on the disk. One of the methods is to certify the magneto-optical disk before using the disk for the first time to detect a defect. This method will be referred to as the “primary method of defect management.” With this method, the address of the defective area detected is recorded in DMAs so as not to use the defective area subsequently.

The second method is the management of a defective area which is found mainly after certification. With this method, data is written to the disk, and written data is read from the disk to check the data for correctness. If the area to which the data is written is found defective, the defective area and a substitute area are registered (secondary method of defect management). In this case, information as to the defect is stored once in the memory 8 of the digital camera and written to the DMAs of the disk 4 at desired time.

With this method, the data as to the defective sector is written to DMAs, and the sector to be used for recording or playback is checked with reference to the data in DMAS. It therefore follows that unless DMA is readable, the data recording area or the location of the area can not be identified. Thus, for correct recording on or reproduction from the disk, it is of extreme importance to record correct data in DMAs and to reproduce the data from DMAs. For example, if failure occurs in writing data in DMAs for one cause or another, the most objectionable situation will be encountered in that image data, although recorded on the disk, can not be reproduced from the disk because the defective area or substitute area can not be identified. The present invention has overcome this problem experienced with the secondary method of defect management.

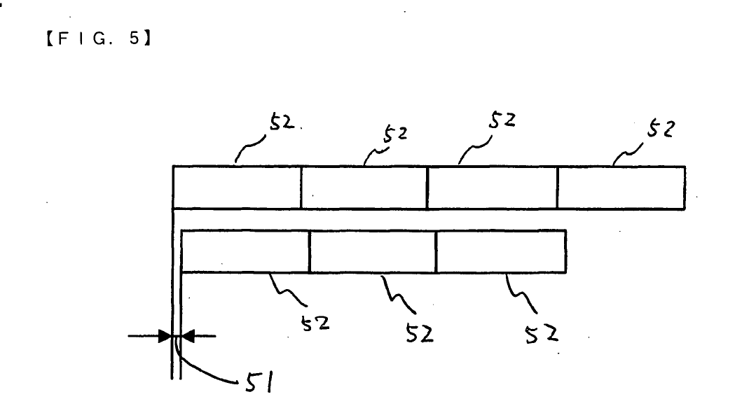

The data reading or writing unit of the magneto-optical drive 3 is a block unit including error correction. Recording or reproduction by the magneto-optical drive 3 is conducted in units of 32 K bytes according to the present embodiment. The unit is termed “ECC block,” and one DMA includes four ECC blocks 52, 52 (see FIG. 5).

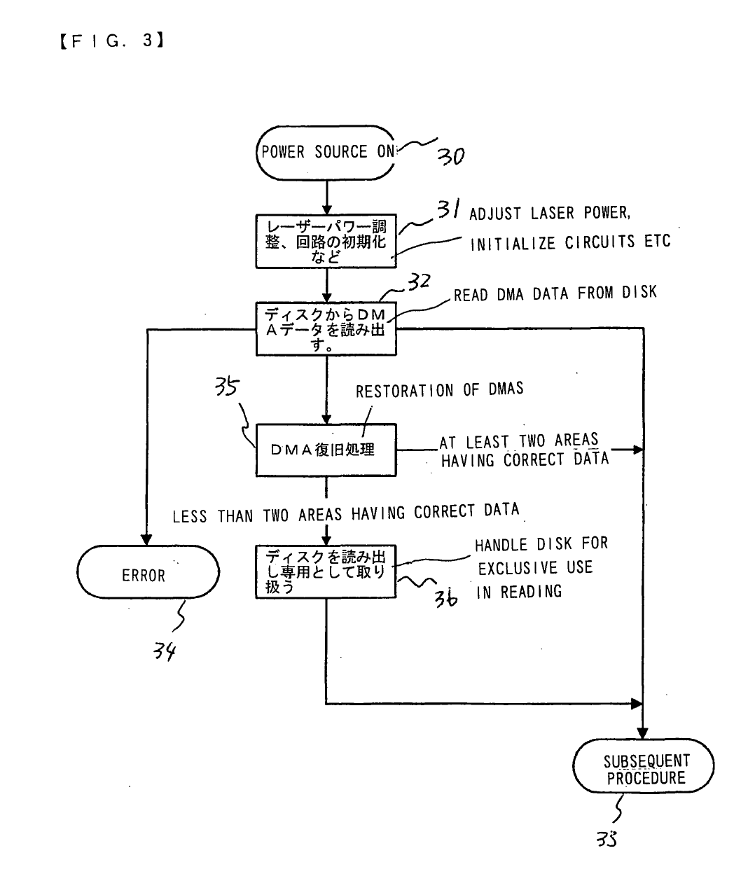

FIG. 3 shows a reading operation, which will be described first. In the digital camera for practicing the present invention, a magneto-optical disk 4 is placed on the magneto-optical drive 3, and the power source is turned on (step 30). The drive 3 adjusts the laser power of a pickup and initializes other circuits (step 31). Data is read from DMAs (step 32).

At this time, the data is read from DMAs in the order of I1->I2->O1->O2. When the data is correctly read from two DMAS, the data is not read from the subsequent DMAs, and step 33 then follows for next procedure based on the DMA data obtained. If no correct DMA data is obtained, step 34 follows for error processing.

When the data is read correctly from only one DMA in reading four DMAs, DMAs are restored (step 35). The restoration means the step of writing the read data to the DMAs failing to provide the correct data through reading. Stated more specifically, since the correct data is read from one DMA, this data is written to the other three DMAs. After writing, the data is read from these DMAs to check whether the data is recorded correctly.

The sequence proceeds to step 33 if at least two DMAs have the correct data stored therein as the result of restoration (that is, if at least one DMA is found to have the correct data recorded therein by restoration).

Conversely if the number of DMAs having the correct data recorded therein can not be increased despite the restoration, step 36 follows, in which a flag is set to indicate that the disk concerned is to be subsequently used exclusively for playback. This prohibits writing of data to the disk having DMAs failing to afford correct data by reading, thus obviating the likelihood of damaging the data previously written.

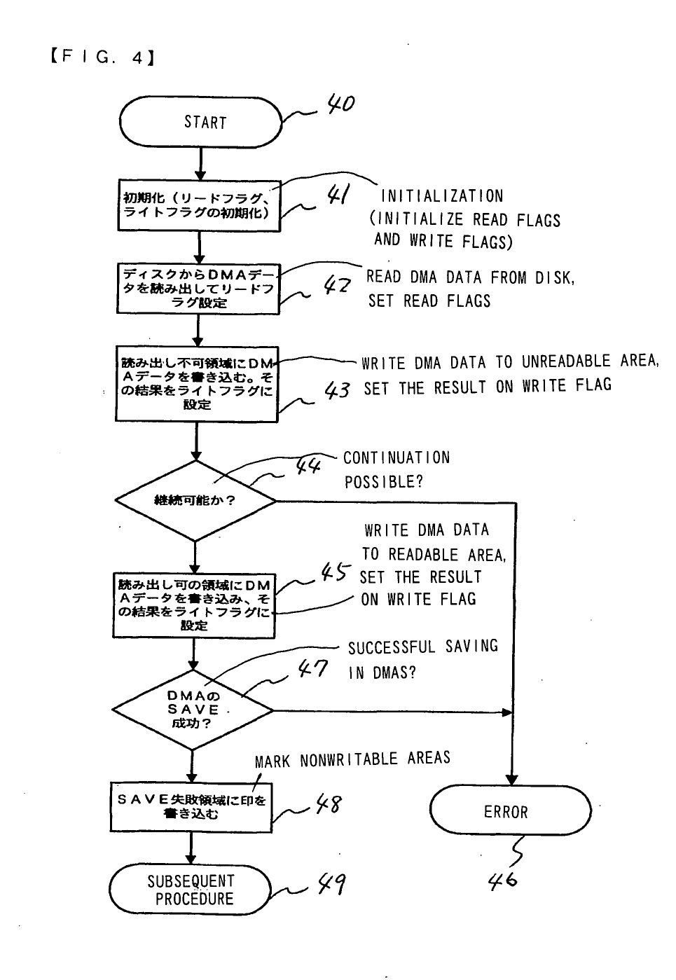

FIG. 4 is a flow chart showing an operation of writing data to DMAs. According to the embodiment of the invention, when image data has been recorded after photographing a still picture, the data recorded in the memory 8 is written to the four DMAs, i.e., I1, I2, O1, O2. In other words, recording is completed after the data is written to the DMAs when a still picture is taken.

In actually writing the image data to the disk, the disk is checked every predetermined recording-playback unit as to whether the correct data has been recorded, and if otherwise, the area concerned is interpreted as a defective area, and the address of the area and that of a substitute area are stored in the memory 8. This data needs to be recorded in the four DMAs on the disk. Thus, the data as to the defective area is written to the DMAs of the disk at desired time, whereby the disk DMAs are always held in the latest state. The data is written to the DMAs in all the four ECC blocks 52, 52.

In writing data to DMAs, read flags and write flags are all set false (step 41). These flags correspond to the individual DMAs and can be set at four independent values, respectively. In other words, checking the flag indicates whether data can be read from or written to the corresponding DMA. At the start of the operation, the read flags and write flags are all set at false values.

Next, data is read from the four DMAs to check whether reading is possible. For each DMA, the result of checking whether reading is possible is set on the read flag. Stated more specifically, when data can be read from a particular DMA, a true value is recorded in that DMA. If otherwise, the value in the corresponding DMA remains false. Checking whether the data can be read is made under the same condition as checking whether the read data is correct as will be described in detail later.

Next in step 43, data to be written is recorded in the DMA from which it was found impossible to read data in step 42. After writing at this time, data is read from the same DMA, and when the data is found to have been recorded correctly, this is interpreted as indicating that the data has been written successfully for the first time. The write flag for the DMA to which the data has been successfully written is set to a true value. Thus, the data is written also to the DMA failing to permit reading because there is some DMA from which data can be read successfully even if it was impossible to write the latest defect information thereto, such that the DMA is maintained in the state before the latest image data is written thereto. Even in the event of failing to write data to DMA, the data successfully read from DMA can be utilized to ensure at least the playback of the disk.

Next in step 44, the current state of the flags is checked to determine whether it is appropriate to effect the subsequent processing. Continued processing is possible on condition that there are at least two readable DMAs, or there is at least one DMA to which writing is possible. Unless continued processing is possible, step 46 follows for error processing.

If continuation is possible, that is, if the requirement of step 44 is fulfilled, the data to be written currently is written in step 45 to the DMA from which it was found possible to read data in step 42. The write flag is set to a value indicating successful writing. If at least two DMAs are found successful in writing data thereto by checking the write flags, this is interpreted as indicating successful writing to the DMAs. The next step then follows (step 47). If it is found possible to write to one DMA only, step 46 follows for error processing.

The DMA comprises four ECC blocks 52, 52 (see FIG. 5). Each ECC block 52 comprises 16 frames (physical address defining frames).

In step 48, the DMA to which it was found impossible to write data is so marked as not to be used in error. Stated more specifically with reference to FIG. 5, data corresponding to three blocks 52, 52 is written as shifted by an amount of one frame 51 to the DMA. These blocks are filled with invalid data. This step renders the DMA no longer usable subsequently, eliminating the likelihood that use of data in a DMA to which it was impossible to write data in error will produce conflict with the data in other DMA to result in errors in recording-reproducing operation.

Whether the data in the DMA is correct or not is judged in the following manner. The data is judged as being incorrect when the four ECC blocks 52, 52 providing DMA have an error remaining uncorrected, or when the data, even if read, is not in conformity with the specified data structure in the DMA, for example, depending on the content of the specified header.

1. An information recording-reproducing method characterized in that when information can be correctly read from a plurality of defect management areas in reading defect management information from a recording medium including detect management areas, reading data from or writing data to the recording medium is permitted, the recording medium being handled as a recording medium for exclusive use in reproduction when information can be read from only one of the areas.

2. An information recording-reproducing method according to claim 1 which is characterized in that when there is an area failing to provide information through reading in reading the defect management information, the data successfully read from an area is written to the area failing to provide the information through reading.

3. An information recording-reproducing method according to claim 1 which is characterized in that in updating the defect management information during a recording-reproduction operation for the recording medium, the defect management information is updated after the detect management information has been read from all the defect management areas.

4. An information recording-reproducing method according to claim 1 which is characterized in that when the defect management information can be updated at only one location, the recording medium is handled as a recording medium for exclusive use in reproduction.

5. An information recording device characterized in that when information can be correctly read from a plurality of defect management areas in reading defect management information from a recording medium including detect management areas, reading data from or writing data to the recording medium is permitted, the recording medium being handled as a recording medium for exclusive use in reproduction when information can be read from only one of the areas.

6. An information recording device according to claim 5 which is characterized in that when there is an area failing to provide information through reading in reading the defect management information, the data successfully read from an area is written to the area failing to provide the information through reading.

7. An information recording device according to claim 5 which is characterized in that in updating the defect management information during a recording-reproduction operation for the recording medium, the defect management information is updated after the detect management information has been read from all the defect management areas.

8. An information recording device according to claim 5 which is characterized in that when the defect management information can be updated at only one location, the recording medium is handled as a recording medium for exclusive use in reproduction.

9. A digital camera provided with an information recording device according to claims 5 to 8.
